(19) United States
(12) Patent Application Publication
(10) Pub. No.: US 2011/0157511 A1
(43) Pub. Date: Jun. 30, 2011

(54) DISPLAY DEVICE

(76) Inventors: Cheng-Hung Hsu, Taipei Hsien (TW); Sheng-Chieh Yang, Taipei Hsien (TW); Chi-Wei Kuo, Taipei Hsien (TW); Hsueh-Ping Yang, Taipei Hsien (TW)

(21) Appl. No.: 12/908,006

(22) Filed: Oct. 20, 2010

(30) Foreign Application Priority Data
Dec. 24, 2009 (TW) 098144717

(51) Int. Cl. G02F 1/1333

(52) U.S. Cl. 349/58

(57) ABSTRACT

A display device includes a front bezel, a back bracket and a panel module. The back bracket is assembled with the front bezel. The panel module is disposed between the front bezel and the back bracket. Since the invention assembles the front bezel, the panel module and the back bracket without a front bracket and frame of the prior art, the number of components and the cost of the display device can be reduced effectively.

### BACKGROUND OF THE INVENTION

1. Field of the Invention

The invention relates to a display device and, more particularly, to a display device integrating a front bezel with a panel module, so as to reduce the number of components and the cost of the display device effectively.

2. Description of the Prior Art

Referring to FIGS. 1 to 3, FIG. 1 is a perspective view illustrating a liquid crystal display (LCD) device 1 of the prior art, FIG. 2 is an exploded view illustrating the LCD device 1 shown in FIG. 1, and FIG. 3 is an exploded view illustrating the LCD panel module 12 shown in FIG. 2. As shown in FIGS. 1 and 2, the LCD device 1 comprises a front bezel 10 and an LCD panel module 12. As shown in FIG. 3, the LCD panel module 12 comprises a front bracket 120, an LCD panel 121, two diffuser sheets 122, a diffuser plate 123, a prism sheet 124, a reflective film 125, three frames 126, two wire fixing members 127, a back bracket 128 and a shielding component 129.

In general, the front bracket 120 and the back bracket 128 are made of metal (e.g. iron), and the frames 126 are made of plastic. The prior art utilizes the front bracket 120, the back bracket 128 and the frames 126 to accommodate and fix the LCD panel 121, the diffuser sheets 122, the diffuser plate 123, the prism sheet 124, the reflective film 125, the wire fixing members 127 and a shielding component 129, so as to form the LCD panel module 12 shown in FIG. 2. Afterward, the LCD panel module 12 can be assembled with the front bezel 10, so as to form the LCD device 1 shown in FIG. 1.

In the prior art, since the LCD panel module 12 is manufactured by panel makers in advance, the panel makers have to utilize the front bracket 120 and the frames 126 to fix the aforesaid components on the back bracket 128. Then, system integration company purchases the LCD panel module 12 from the panel makers and assembles the LCD panel module 12 with the front bezel 10. In the LCD device 1, the function of the front bracket 120 and the frames 126 is the same as the front bezel 10 used for purpose of fixing. If the system integration company can purchase the LCD panel 121 from the panel makers directly and then assembles the LCD panel 121, a backlight module including the diffuser sheets 122, the diffuser plate 123, the prism sheet 124, the reflective film 125, and so on with the front bezel 10 and the back bracket 128 without the front bracket 120 and the frames 126 by Liquid Crystal Display Module (LCM) process, the number of components and the cost of the display device 1 can be reduced effectively. Accordingly, the production efficiency can be improved, the assembly cost can be reduced, and the transportation cost of components can be also reduced.

In addition, the aforesaid shielding component 129 is used to protect the circuit board within the LCD panel module 12 from damage due to Electromagnetic Interference (EMI) or Electrostatic Discharge (ESD) during transportation. If the LCD device 1 can be assembled by LCM process directly, the shielding component 129 can be further saved.

### SUMMARY OF THE INVENTION

Therefore, one objective of the invention is to provide a display device integrating a front bezel with a panel module, so as to reduce the number of components and the cost of the display device effectively.

According to one embodiment of the invention, a display device comprises a front bezel, a back bracket and a penal module. The back bracket is assembled with the front bezel. The panel module is disposed between the front bezel and the back bracket. In practical applications, since the invention assembles the front bezel, the panel module and the back bracket without a front bracket, frames and a shielding component of the prior art, the number of components and the cost of the display device can be reduced effectively. Accordingly, the production efficiency can be improved, the assembly cost can be reduced, and the transportation cost of components can be also reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a liquid crystal display (LCD) device of the prior art.

FIG. 2 is an exploded view illustrating the LCD device shown in FIG. 1.

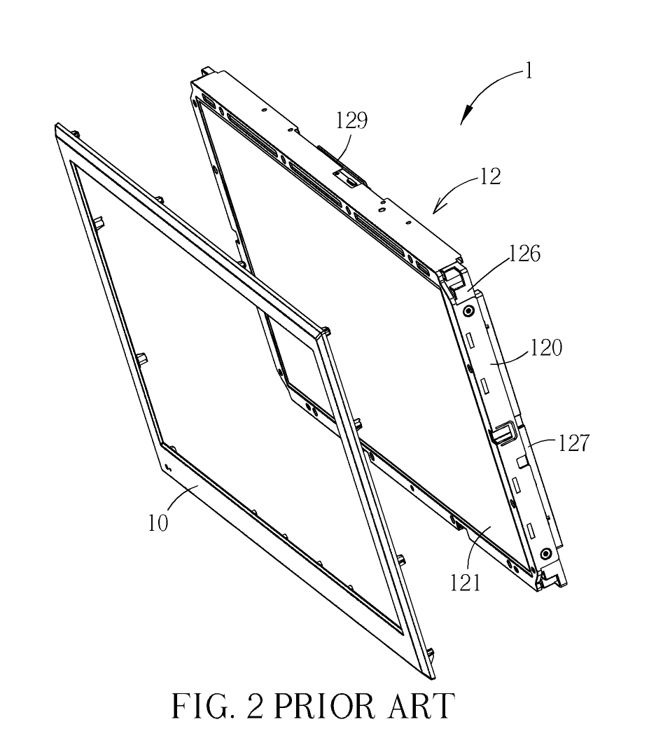

FIG. 3 is an exploded view illustrating the LCD panel module shown in FIG. 2.

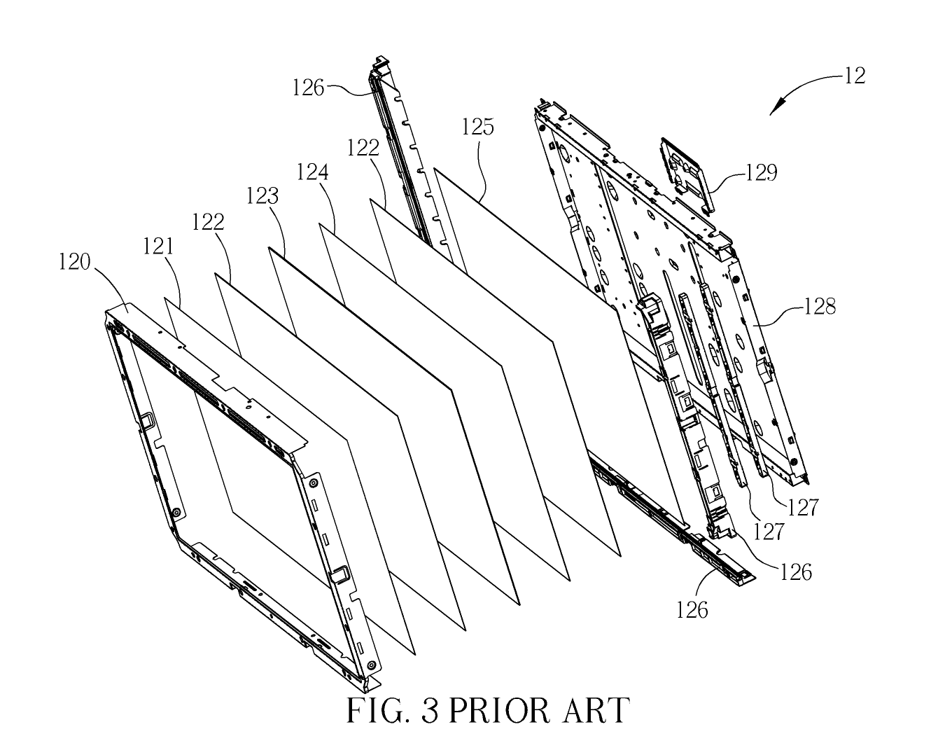

FIG. 4 is a perspective view illustrating a display device according to one embodiment of the invention.

FIG. 5 is an exploded view illustrating the display device shown in FIG. 4.

FIG. 6 is a rear perspective view illustrating the display device shown in FIG. 4.

### DETAILED DESCRIPTION

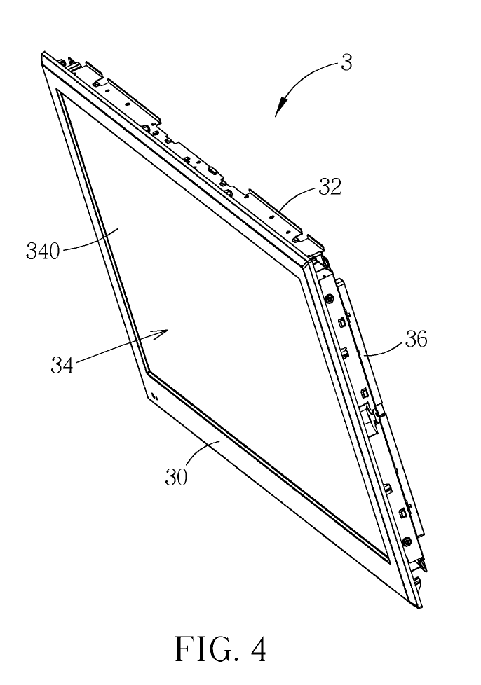

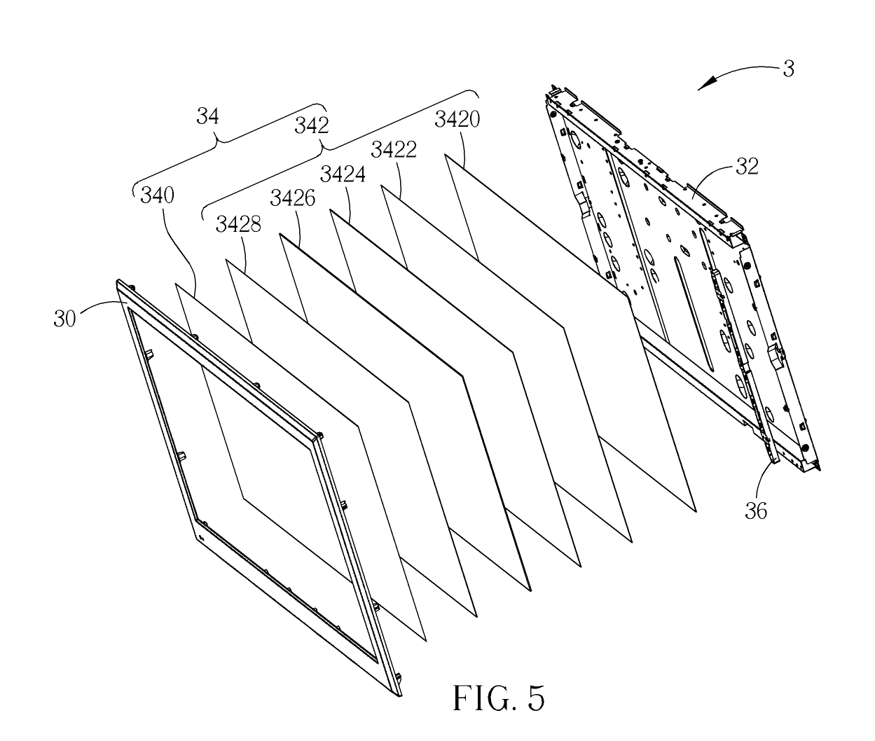

Referring to FIGS. 4 and 5, FIG. 4 is a perspective view illustrating a display device 3 according to one embodiment of the invention, and FIG. 5 is an exploded view illustrating the display device 3 shown in FIG. 4. As shown in FIGS. 4 and 5, the display device 3 comprises a front bezel 30, a back bracket 32 and a panel module 34. The back bracket 32 is assembled with the front bezel 30. The panel module 34 is disposed between the front bezel 30 and the back bracket 32. In this embodiment, the panel module 34 comprises a display panel 340 and a backlight module 342, wherein the display panel 340 is disposed on the backlight module 342. The backlight module 342 comprises a reflective film 3420, a first diffuser sheet 3422, a prism sheet 3424, a diffuser plate 3426 and a second diffuser sheet 3428. The first diffuser sheet 3422 is disposed on the reflective film 3420, the prism sheet 3424 is disposed on the first diffuser sheet 3422, the diffuser plate 3426 is disposed on the prism sheet 3424, and the second diffuser sheet 3428 is disposed on the diffuser plate 3426. Furthermore, the display device 3 further comprises a wire fixing member 36 disposed on the back bracket 32. The wire fixing member 36 is used to fix a conducting wire (not shown), which is connected to a light source.

In practical applications, the display device 3 can be, but not limited to, a liquid crystal display (LCD) device, and the display panel 340 can be, but not limited to, an LCD panel. Moreover, the light source of the backlight module 342 can be, but not limited to, a cold cathode fluorescent lamp (CCFL) or a light emitting diode (LED). It should be noted that the principle of the backlight module 342 and the display panel 340 can be achieved by one skilled in the art and will not be depicted herein.

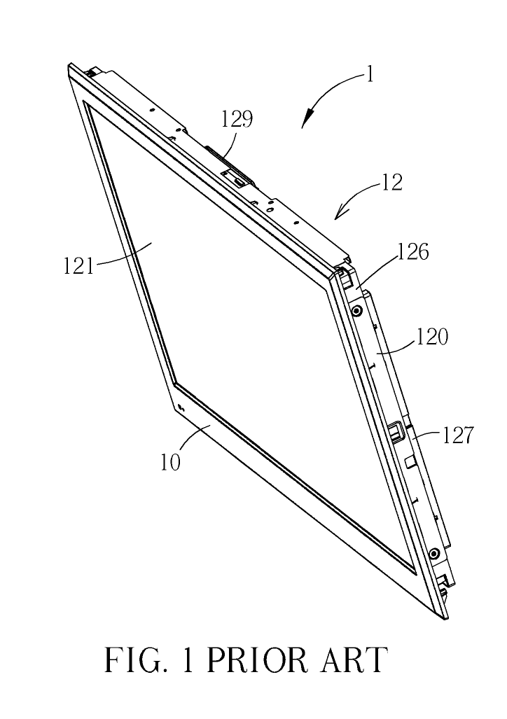

As shown in FIGS. 4 and 5, the invention assembles the display panel 340 with the front bezel 30 directly and then assembles the display panel 340 and the front bezel 30 with the backlight module 342 and the back bracket 32. Compared with the LCD display device 1 of the prior art shown in FIG. 1, the display device 3 saves the front bracket 120 and the frames 126. In this embodiment, the system integration company only has to purchase the display panel 340 rather than purchasing the whole LCD display panel 12 from the panel makers. Since the number of components is reduced, the total cost including assembly cost of the display device 3 of the invention will be reduced and the production efficiency will be improved correspondingly.

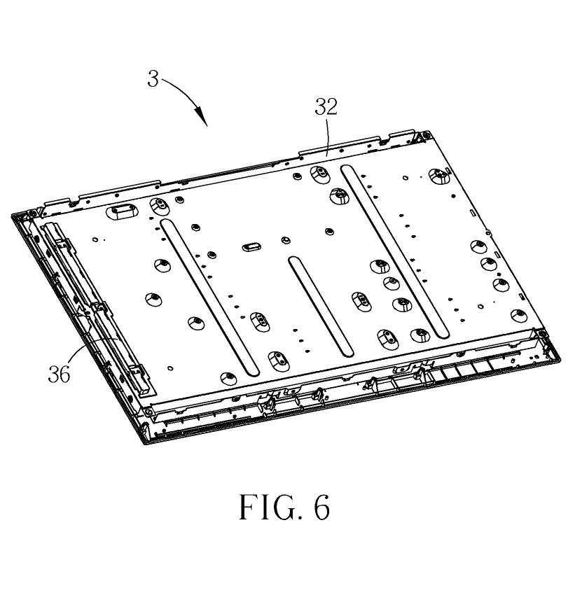

Referring to FIG. 6, FIG. 6 is a rear perspective view illustrating the display device 3 shown in FIG. 4. As shown in FIG. 6, there is a plurality of screw holes formed on the back of the back bracket 32, and the invention may utilize screws to assemble the front bezel 30 with the back bracket 32. Furthermore, the front bezel 30 can be also assembled with the back bracket 32 by engaging structures, and it depends upon practical applications.

In practical applications, the invention assembles the front bezel 30, the panel module 34 and the back bracket 32 without a front bracket 120 and frames 120 of the prior art (shown in FIG. 1). Moreover, since the display device 3 of the invention can be assembled by LCM process directly, the shielding component 129 of the prior art (shown in FIG. 1) can be further saved. Accordingly, the number of components and the cost of the display device 3 can be reduced effectively. Consequently, the production efficiency can be improved, the assembly cost can be reduced, and the transportation cost of components can be also reduced.

Those skilled in the art will readily observe that numerous modifications and alterations of the device and method may be made while retaining the teachings of the invention.

What is claimed is:

1. A display device comprising:
a front bezel;
a back bracket assembled with the front bezel; and
a panel module disposed between the front bezel and the back bracket.

2. The display device of claim 1, wherein the front bezel is assembled with the back bracket by screws.

3. The display device of claim 1, wherein the front bezel is assembled with the back bracket by engaging structures.

4. The display device of claim 1, wherein the panel module comprises:
a backlight module; and
a display panel disposed on the backlight module.

5. The display device of claim 4, wherein the backlight module comprises:
a reflective film;
a first diffuser sheet disposed on the reflective film;
a prism sheet disposed on the first diffuser sheet;
a diffuser plate disposed on the prism sheet; and
a second diffuser sheet disposed on the diffuser plate.

6. The display device of claim 4, wherein the display panel is a liquid crystal display panel.

7. The display device of claim 1 further comprising a wire fixing member disposed on the back bracket.
